(19) United States
(12) Patent Application Publication
(10) Pub. No.: US 2024/0412452 A1
(43) Pub. Date: Dec. 12, 2024

(54) SYSTEMS AND METHODS FOR 3D HUMAN MODEL ESTIMATION

(71) Applicant: Shanghai United Imaging Intelligence Co., Ltd., Shanghai (CN)

(72) Inventors: Meng Zheng, Cambridge, MA (US); Xuan Gong, Sunnyvale, CA (US); Benjamin Planche, Briarwood, NY (US); Ziyan Wu, Lexington, MA (US)

(73) Assignee: Shanghai United Imaging Intelligence Co., Ltd., Shanghai (CN)

(21) Appl. No.: 18/206,874

(22) Filed: Jun. 7, 2023

(51) Int. Cl. G06T 17/00; G06T 7/73

(52) U.S. Cl. CPC G06T 17/00; G06T 7/73

(57) ABSTRACT

Disclosed herein are systems, methods and instrumentalities associated with multi-view 3D human model estimation using machine learning (ML) based techniques. These techniques may use synthetically generated data to train an ML model that may be used to progressively regress a 3D human body model based on multi-view 2D images. The training data may be synthetically generated based on statistical distributions of human poses and human body shapes, as well as a statistical distribution of camera viewpoints. The progressive regression may be performed based on consensus features shared by the multi-view images and diversity features derived from at least one of the multi-view images. Consistency between the multi-view images may also be maintained during the regression process.

### BACKGROUND

In computer vision, the pose and/or body shape of a person may be estimated and visualized by recovering a three-dimensional (3D) body model of the person based on one or more two-dimensional (2D) images that depict the person in the pose and/or body shape. In recent years, neural network based technologies have been increasingly used to perform the body model recovery task, but these existing technologies are generally single-view based and require a large amount of annotated data for network training. A single-view based model recovery approach may suffer from depth ambiguities and consequently have low generalizability. Annotated training data may also be difficult to acquire. Accordingly, the existing 3D body model recovery technologies cannot satisfy the requirements of real-world application scenarios, such as, e.g., automated patient modeling and positioning in a medical facility.

### SUMMARY

Disclosed herein are systems, methods and instrumentalities associated with multi-view 3D human model recovery (HMR). An apparatus configured to the perform the HMR task may include at least one processor configured to obtain a first 2D feature representation based on a first 2D image depicting a first view of a person in a pose and a body shape, and further obtain a second 2D feature representation based on a second 2D image depicting a second view of the person in the pose and the body shape. The at least one processor may be further configured to determine a 3D body model (e.g., a parametric mesh model or a non-parametric mesh model) that may represent the pose and the body shape of the person based on a machine-learning (ML) model, wherein the ML model may be trained to predict the 3D body model based at least on the first 2D feature representation and the second 2D feature representation. The ML model may be trained using synthetically generated training data that may include a 3D training body model sampled from a human body model distribution and respective 2D training feature representations associated with different camera views of the 3D training body model. Each of these camera views of the 3D training body model may be associated with a respective set of camera parameters that may be sampled from a camera viewpoint distribution, and the respective 2D training feature representation associated with each of the camera views may be obtained based on features extracted from a 2D image that may correspond to a projection of the 3D training body model to a 2D image space based on the respective set of camera parameters associated with the camera view.

In examples, the first 2D feature representation described herein may include a first feature map, a first mask, or a first heatmap associated with a plurality of joint locations of the person as depicted by the first 2D image, while the second 2D feature representation may include a second feature map, a second mask, or a second heatmap associated with the plurality of joint locations of the person as depicted by the second 2D image. In examples, the ML model may be used to inverse-project the first 2D feature representation and the second 2D feature representation into a 3D space to obtain a first set of 3D features and a second set of 3D features, respectively. The ML model may be further used to obtain a first 3D body model based on an intersection of the first set of 3D features and the second set of 3D features, obtain a second 3D body model based on the first 3D body model and a union of the first set of 3D features and the second set of 3D features, and determine the 3D body model that represents the pose and the body shape of the person based at least on the second 3D body model.

In examples, the second 3D body model obtained via the progressive process may be further refined based on a weighted combination of the first set of 3D features and the second set of 3D features, in which the first set of 3D features may be weighed by a first consistency score and the second set of 3D features may be weighed by a second consistency score in the weighted combination. The first consistency score may be determined based on a difference between the first 2D feature representation obtained based on the first 2D image and a first projected 2D feature representation obtained by projecting the second 3D body model into a 2D image space, while the second consistency score may be determined based on a difference between the second 2D feature representation obtained based on the second 2D image and a second projected 2D feature representation obtained by projecting the second 3D body model into the 2D image space.

The ML model described herein may be implemented using an artificial neural network that may include one or more convolutional layers. The person for whom the 3D body model is constructed may a patient, in which case the at least one processor may be further configured to position the person for a medical procedure based on the 3D body model.

### BRIEF DESCRIPTION OF THE DRAWINGS

A more detailed understanding of the examples disclosed herein may be had from the following description, given by way of example in conjunction with the accompanying drawings.

FIG. 1 is a simplified block diagram illustrating an example of constructing a 3D body model for a person based on a machine learning (ML) model and multi-view 2D images of the person.

FIG. 2 is another simplified block diagram illustrating example operations that may be associated with constructing a 3D body model for a person based on multi-view 2D images of the person and an ML model.

FIG. 3 is a simplified diagram illustrating an example of a progressive regression process for recovering a 3D body model of a person.

FIG. 4 is a diagram illustrating an example of refining a 3D body model for person to maintain consistency between different views of the person.

FIG. 5 is a flow diagram illustrating example operations that may be associated with training a neural network to perform one or more of the tasks described herein.

FIG. 6 is a simplified block diagram illustrating example components of an apparatus that may be used to perform one or more of the tasks described herein.

### DETAILED DESCRIPTION

The present disclosure is illustrated by way of example, and not by way of limitation, in the figures of the accompanying drawings. A detailed description of illustrative embodiments will be described with reference to these figures. Although the description may provide examples of possible implementations, it should be noted that the details are intended to be illustrative and in no way limit the scope of the application. It should also be noted that, while the examples may be described in the context of a medical environment, those skilled in the art will appreciate that the disclosed techniques may also be applied to other environments or use cases.

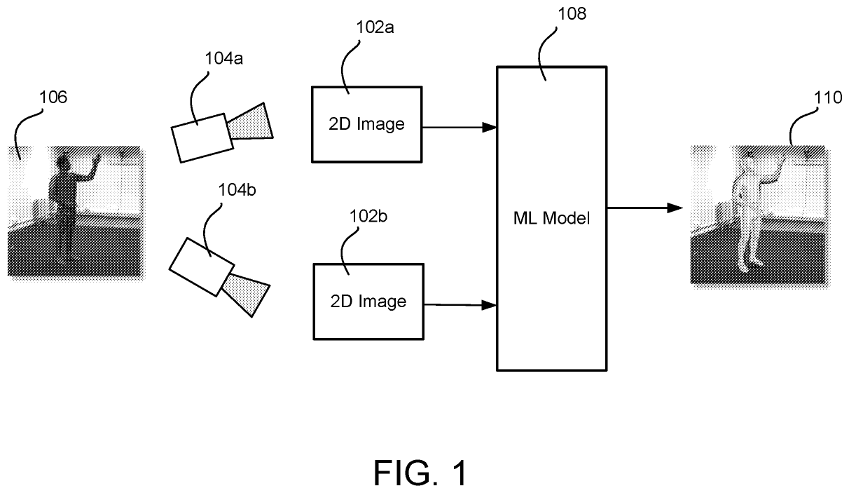

FIG. 1 is a diagram illustrating an example of using machine learning (ML) based technologies and multi-view images (e.g., 2D images) to construct a 3D body model for visualizing the pose and/or body shape of a person. As shown, the multi-view images (e.g., 102a, 102b, etc.) may be captured using one or more image sensing devices (e.g., 104a, 104b, etc.) that may be installed in an environment 106 (e.g., a medical facility such as a scan room or an operating room) where the person may be present. The image sensing devices may include cameras, depth sensors, thermal sensors, radar sensors, etc., and, based on where the image sensing devices are installed, the images (e.g., 102a, 102b, etc.) may capture different views of the person (e.g., a first view by sensing device 104a, a second view by sensing device 104b, etc.) in the pose and/or body shape. It should be noted that, although two images (e.g., 102a and 102b) and two sensing devices (e.g., 104a and 104b) are shown in FIG. 1, those skilled in the art will appreciate that more than two images or more than two sensing devices may be used to accomplish the body model recovery task described herein. Those skilled in the art will also appreciate that, in some implementations, a single image sensing device capable of being oriented at different angles (e.g., viewpoints) towards the person may be used to accomplish the body model recovery task described herein.

The multi-view images (e.g., 102a, 102b, etc.) may be processed (e.g., by a body model recovery apparatus) based on an ML model 108, which may be trained to generate (e.g., predict) a 3D body model 110 based on the multi-view images (e.g., based at least on image 102a and image 102b). As will be described in greater detail below, ML model 108 may be implemented via one or more artificial neural networks (ANNs), and may include multiple components. One set of components of the ML model may be configured to extract 2D features from the multi-view images and generate 2D feature representations based on the extracted features, while another set of components of the ML model may be configured to obtain 3D features based on the 2D feature representations and predict the 3D huma model 110 based on the 3D features. The ML model may be trained using synthetically generated data that may include, for example, a 3D training body model (e.g., sampled from a human body model distribution) and respective 2D training feature representations that may be associated with different camera views (e.g., sampled from a camera view distribution) of the 3D training body model.

The 3D body model 110 generated (e.g., predicted) using the techniques described herein may be a parametric model (e.g., comprising one or more pose parameters, θ, and one or more shape parameters, B) or a non-parametric model. In examples, the 3D body model 110 may be a mesh model, which may be constructed, for example, by determining a plurality of vertices based on the pose and shape parameters described above (e.g., 6890 vertices based on 82 shape and pose parameters), connecting multiple vertices with edges to form a polygon, connecting multiple polygons to form a surface, using multiple surfaces to determine a 3D shape, and applying texture and/or shading to the surfaces and/or shapes. The 3D huma model 110 may be used for various purposes. For example, the 3D body model 110 may be used to determine the position and/or pose of the person before or during a medical scan to ensure that the person is ready for the scan. As another example, the 3D body model 110 may be used to determine the body shape of the person (e.g., which indicate the person's body size and/or body weight) so as to determine a proper dosage level of a medical treatment for the person. As yet another example, the 3D body model 110 may be used to monitor the movements of the person inside a medical facility or during a medical procedure.

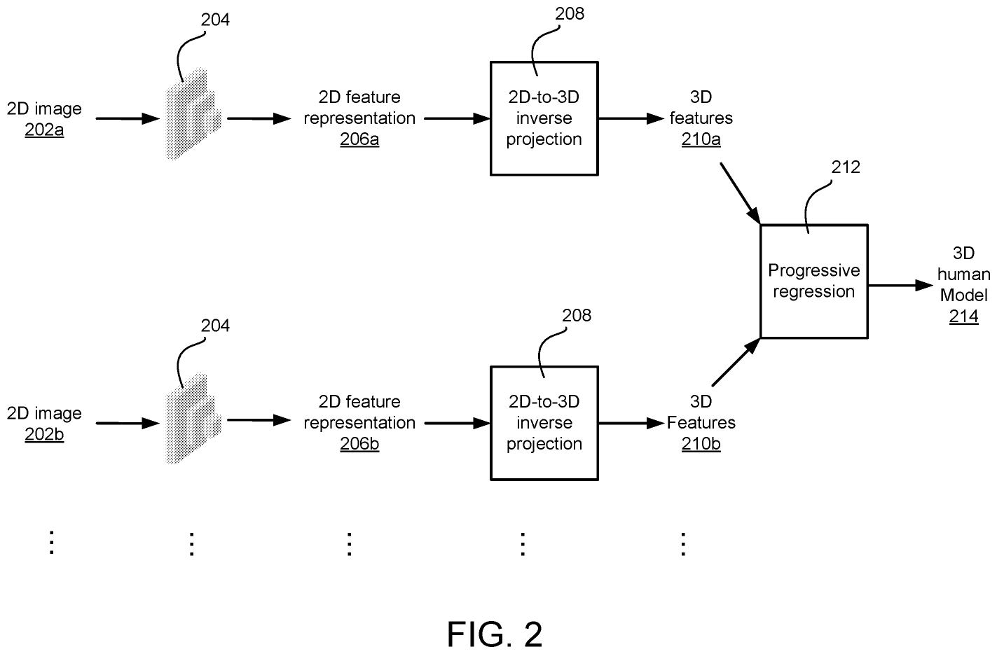

FIG. 2 illustrates example operations that may be associated with recovering a 3D body model of a person (e.g., 3D body model 110 of FIG. 1) based on multi-view 2D images of the person (e.g., images 102a and 102b of FIG. 1) and an ML model (e.g., ML model 108 of FIG. 1). Two images (e.g., 202a and 202b) are shown in FIG. 2, but those skilled in the art will appreciate that more images may be used to recover the 3D body model. As shown, the recovery operations may include extracting features from each of the 2D images at 204 and obtaining respective 2D feature representations (e.g., 206a and 206b) for the 2D images as a result of the extraction. In examples, the feature extraction may be performed using an artificial neural network that may include a convolutional neural network (CNN) as a backbone. The CNN may include one or more convolutional layers (e.g., with associated linear or non-linear activation functions), one or more pooling layers, and/or one or more fully connected layers. Each of these layers may include a plurality of filters (e.g., kernels) configured to detect features (e.g., features associated with joint locations of the person) in the 2D image 202a or 202b. The filters may be associated with respective weights that, when applied to an input, produce an output indicating whether certain features have been detected. The weights may be learned by the neural network through a training process that may include providing a large number of images from a training dataset to the neural network, using the neural network to predict a result (e.g., joint locations) using present values of the weights, calculating a difference or loss between the prediction and a corresponding ground truth based on a loss function (e.g., mean squared errors), and updating the values of the weights with an objective to minimize the difference or loss (e.g., based on a stochastic gradient descent of the loss).

The features extracted by the CNN from each of the 2D images (e.g., referred to herein as 2D features) may be represented via a respective 2D feature representation (e.g., 206a or 206b). Such a 2D feature representation may take various forms. For example, the 2D feature representation may include a feature map, a feature vector, a sparse 2D representation such as a skeleton that may indicate the joint locations of the person, or a dense 2D representation such as a binary mask comprising Boolean values that may indicate whether or not corresponding pixels belong to a joint location, or a heatmap comprising non-Boolean values that may indicate the respective probabilities at which corresponding pixels may belong to a joint location.

Once the 2D feature representations (e.g., 206a and 206b) of the multiple views (e.g., represented by images 202a and 202b) are obtained, the recovery operations may further include inverse-projecting (e.g., which may also be referred to herein as un-projecting) the 2D feature representation associated with each view into a 3D space at 208 to derive corresponding 3D features (e.g., 210a, 210b, etc.) for the view. The inverse projection may be accomplished using various techniques including, for example, volumetric triangulation, through which the 2D feature representations may be un-projected along projection rays to fill a shared 3D cube. In examples, such a 3D cube may be represented by a 3D bounding box (e.g., with a dimension of L×L×L) in the global space discretized by a G×G×G volumetric grid, where G may represent the number of voxels along each axis. Each voxel may be filled with the global coordinates of the voxel center to obtain V^{coords} ∈R^{G×G×G×3}, and V^{coords} may be projected to an image plane to derive its corresponding 2D pixel index V^{proj} ∈ R^{G×G×G×2}. As such, given one or more 2D maps F∈R^{C×H×W} in the image space, the cube V∈R^{G×G×G×C} may be filled via bilinear sampling using V^{proj}. Since this inverse project process may be differentiable (and agnostic to the number of views), it may be learned using a neural network (e.g., as a part of the ML model described herein).

The multi-view 3D features (e.g., 210a, 210b, etc.) derived via the operations described above may be regressed at 212 to predict a 3D body model 214. The regression may be performed in a progressive manner. For example, the 3D features associated with the multiple views may be fused (e.g., by calculating an average or a weighted sum of the features), flattened (e.g., from a higher dimension representation to a lower dimension representation), and passed to a regressor (e.g., a part of the ML model described herein) to predict pose and shape parameters Θ={θ\hat{ }ⱼ, β\hat{ }ⱼ}. The optimization of Θ may be achieved using an iterative error feedback (IEF) technique that may include multiple steps. As will be described in greater detail below, a first step of the progressive regression process may be performed by taking into consideration a consensus of the multi-view 3D features (e.g., based on an intersection of the multi-view 3D features), while a second step of the progressive regression process may be performed by taking into consideration the diversity of the multi-view 3D features (e.g., based on a union of the multi-view 3D features). In examples, a third step of the progressive regression process may also be performed to balance the multi-view 3D features (e.g., 210a and 210b), for example, by weighing the 3D features associated with each view based on a consistency score or measure determined for that view.

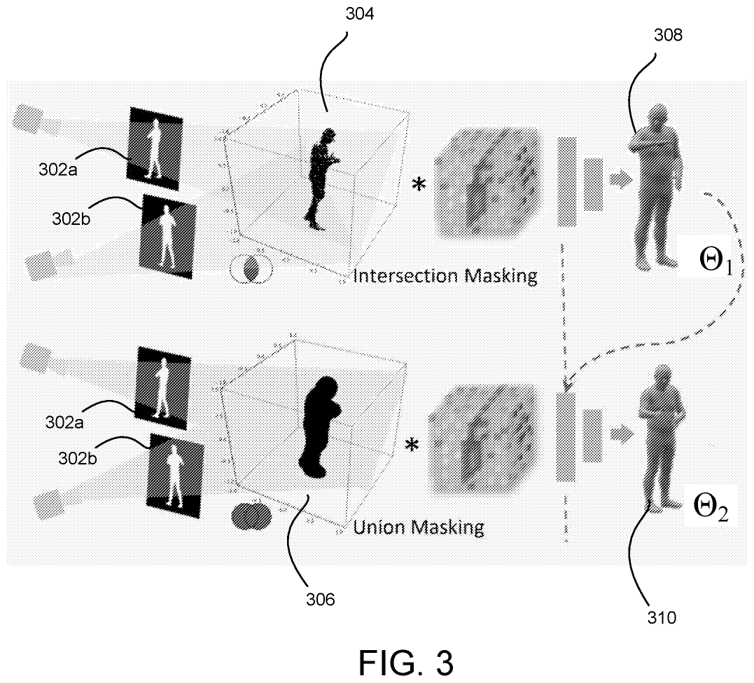

FIG. 3 illustrates an example of a progressive regression process (e.g., the progressive regression process performed at 212 of FIG. 2) for recovering a 3D body model of a person. As shown in the figure, the progress regression may be accomplished based on multiple 2D images (e.g., 302a, 302b, etc.) that may represent different views of the person in a pose and a body shape. From each of these images, 2D features may be extracted (e.g., using the CNN described herein), and a representation of the 2D features may be obtained, for example, in the form of a 2D joints heatmap and/or a binary 2D joints mask. The nonzero areas of the 2D joints heatmap and/or the binary joints mask associated with each image (e.g., 302a or 302b) may be used to obtain a 2D occupancy mask, from which a volumetric occupancy mask in a 3D space may be derived. Multiple such volumetric occupancy masks (e.g., for images 302a, 302b, etc.) may then be aggregated and used to regress a 3D body model for the person. For example, an intersection 304 of these volumetric occupancy masks may represent a consensus occupancy area of interest shared by all of those views, while a union 306 of the volumetric occupancy masks may represent a combined area of interest from all of the views (e.g., referred to herein as a diversity occupancy area). As such, occupancy intersection 304 and occupancy union 306 of the volumetric occupancy masks may be used to mask the 3D features derived based on the 2D images (e.g., using the inverse projection techniques described herein) to obtain fused 3D features in the consensus occupancy area and the diversity occupancy area, respectively.

The 3D consensus features and diversity features may be used to progressively regress a 3D body model for the person. For example, in a first step of such a progressive regression process, the fused 3D features in the consensus occupancy area may be processed via a first set of neural network layers to determine a first 3D body model 308 corresponding to a first set of pose and body shape parameters Θ₁. The first 3D body model may then be processed, together with the fused 3D features in the diversity occupancy area, via a second set of neural network layers to determine a second 3D body model 310 corresponding to a second set of pose and body shape parameters Θ₂ (e.g., in a second step of the progressive regression process). The first and second sets of neural network layers may share parameters (e.g., weights associated with the layers) during training and/or testing, as indicated by the dotted lines in FIG. 3.

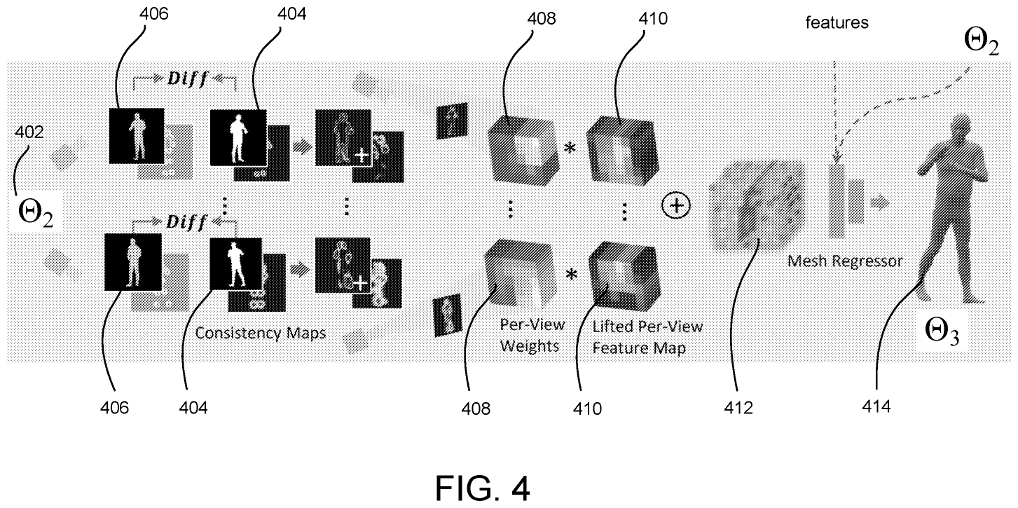

In examples, the 3D body model progressively obtained based on the consensus and diversity features associated with multiple views may be further refined to achieve consistency among those views. FIG. 4 illustrates such an example. As shown, the consistency among multiple views may be achieved based on a current 3D body model prediction 402 (e.g., represented by pose and body shape parameters (2) and 2D feature representations 404 (e.g., joints heatmaps) used to make the current 3D body model prediction. For example, the current 3D body model 402 may be projected to individual 2D image spaces associated with the multiple views (e.g., based on camera parameters associated with the multiple views) to obtain re-projected 2D feature representations 406, which may then be compared to the original 2D feature representations 404 to determine respective consistency maps associated with the multiple views. These consistency maps may indicate respective consistency (or confidence) scores 408 for the respective 3D features derived from the multiple views, and the consistency scores 408 may be used to weigh the view-specific 3D features 410, for example, by calculating a weighted average 412 of the 3D features based on the consistency scores. The weighted 3D features 412 may then be used (e.g., together with currently predicted 3D body model parameters Θ₂ and/or features that may be extracted during the prediction of the currently 3D body model) to generate a refined 3D body model 414 represented by a third set of pose and body shape parameters Θ₃.

The training of the ML model described herein (e.g., ML model 108 of FIG. 1) may be conducted using synthetically generated data and/or in a self-supervised manner. The synthetic data generation may compensate for the lack of multi-view training data for 3D human model recovery, while the self-supervision may eliminate the need for data pairing and annotation. The synthetically generated data may include at least one 3D training body model (e.g., pose parameters θ and/or body shape parameters β associated with the 3D body model) and 2D training feature representations (e.g., joints heatmaps and/or joints masks) associated with the 3D training body model. The pose parameters θ associated with the 3D training body model may be sampled from publicly available motion captured images depicting humans in various poses, while the body shape parameters β may be sampled from a prior statistical normal distribution of human body shapes. Further, the synthesis of 2D training feature representations associated with different camera views of the 3D training body model may be accomplished by sampling an initial camera setting (e.g., intrinsic and/or extrinsic camera parameters) from a camera viewpoint distribution, extending the initial camera setting to multiple cameras via transformation, and determining the respective 2D training feature representations that correspond to different views of the 3D training body model from the multiple cameras based on the camera settings determined for those cameras. The transformation relationships of the cameras may be inferred from a publicly available camera calibration dataset, for example, based on the rotation and translation from a world coordinate system to the coordinate system of each camera. And once the camera setting (e.g., intrinsic and/or extrinsic camera parameters) for a camera is determined via the transformation, a 2D joints heatmap and/or binary joints mask associated with the camera may be obtained by projecting the 3D training body model into a 2D image space based on the determined camera setting to obtain a 2D image, and extracting features (e.g., joint related features) from the 2D image.

The 3D training body model and the 2D training feature representations (e.g., associated with different camera views of the 3D training body model) synthesized using the technique described above may be paired and used to train the ML model under self-supervision. For example, the 2D training feature representations associated with different camera views of the 3D training body model may be inverse-projected into a 3D space to obtain respective sets of 3D features for the different camera views. The intersection and union of the sets of 3D features may then be used to progressively regress an estimated 3D body model, which may be further refined based on consistency scores determined for the 2D training feature representations associated with the different camera views (e.g., using the techniques described herein). The refined 3D body model (e.g., pose and/or body shape parameters associated with the refined 3D body model) may be compared to the original 3D training body model to determine a loss associated with the regression and/or refinement, for example, based on a mean squared error between the estimated 3D body model and the original 3D training body model. The loss may then be used to adjust the parameters of the ML model, for example, by back-propagating a stochastic gradient descent of the loss through the neural network used to implement the ML model.

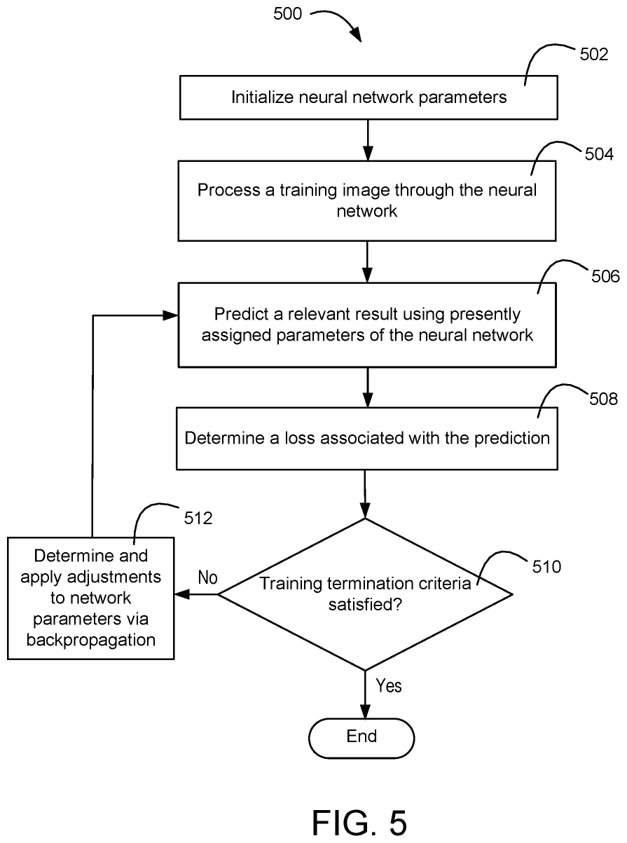

FIG. 5 illustrates example operations that may be associated with training a neural network (e.g., an ML model implemented by the neural network) for performing one or more of the tasks described herein. As shown, the training operations may include initializing the operating parameters of the neural network (e.g., weights associated with various layers of the neural network) at 502, for example, by sampling from a probability distribution or by copying the parameters of another neural network having a similar structure. The training operations may further include processing an input (e.g., a training image) using presently assigned parameters of the neural network at 504, and making a prediction for a desired result (e.g., a feature map or vector, pose and/or shape parameters, etc.) at 506. The prediction result may then be compared to a ground truth at 508 to determine a loss associated with the prediction based on a loss function such as a mean squared error between the prediction result and the ground truth. At 520, the loss may be used to determine whether one or more training termination criteria are satisfied. For example, the training termination criteria may be determined to be satisfied if the loss is below a threshold value or if the change in the loss between two training iterations falls below a threshold value. If the determination at 510 is that the termination criteria are satisfied, the training may end; otherwise, the presently assigned network parameters may be adjusted at 512, for example, by backpropagating a gradient descent of the loss function through the network before the training returns to 506.

For simplicity of explanation, the operations of the methods are depicted and described herein with a specific order. It should be appreciated, however, that these operations may occur in various orders, concurrently, and/or with other operations not presented or described herein. Furthermore, it should be noted that not all operations that the apparatus is capable of performing are depicted in the drawings or described herein. It should also be noted that not all illustrated operations may be required to be performed.

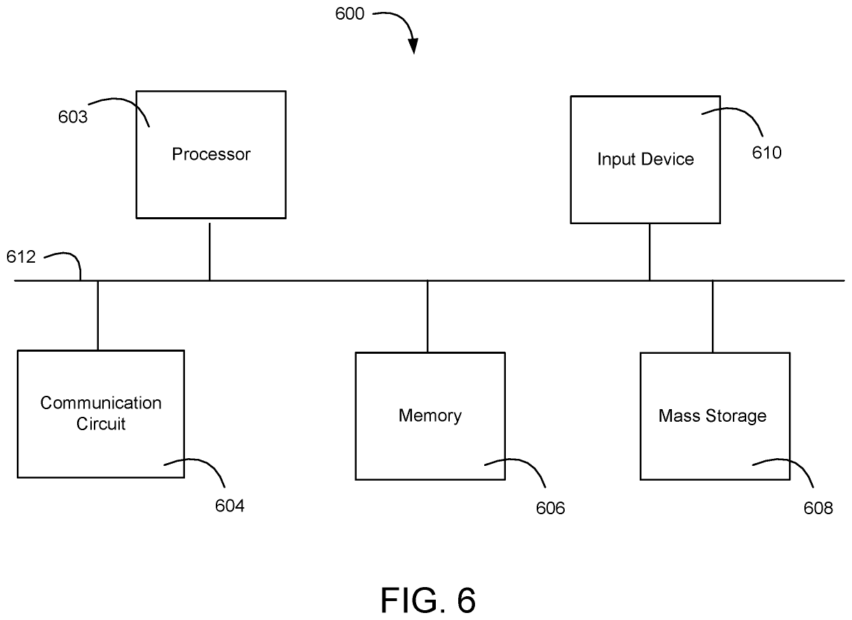

The systems, methods, and/or instrumentalities described herein may be implemented using one or more processors, one or more storage devices, and/or other suitable accessory devices such as display devices, communication devices, input/output devices, etc. FIG. 6 is a block diagram illustrating an example apparatus 600 that may be configured to perform the tasks described herein. As shown, apparatus 600 may include a processor (e.g., one or more processors) 602, which may be a central processing unit (CPU), a graphics processing unit (GPU), a microcontroller, a reduced instruction set computer (RISC) processor, application specific integrated circuits (ASICs), an application-specific instruction-set processor (ASIP), a physics processing unit (PPU), a digital signal processor (DSP), a field programmable gate array (FPGA), or any other circuit or processor capable of executing the functions described herein. Apparatus 600 may further include a communication circuit 604, a memory 606, a mass storage device 608, an input device 610, and/or a communication link 612 (e.g., a communication bus) over which the one or more components shown in the figure may exchange information.

Communication circuit 604 may be configured to transmit and receive information utilizing one or more communication protocols (e.g., TCP/IP) and one or more communication networks including a local area network (LAN), a wide area network (WAN), the Internet, a wireless data network (e.g., a Wi-Fi, 3G, 4G/LTE, or 5G network). Memory 606 may include a storage medium (e.g., a non-transitory storage medium) configured to store machine-readable instructions that, when executed, cause processor 602 to perform one or more of the functions described herein. Examples of the machine-readable medium may include volatile or non-volatile memory including but not limited to semiconductor memory (e.g., electrically programmable read-only memory (EPROM), electrically erasable programmable read-only memory (EEPROM)), flash memory, and/or the like. Mass storage device 608 may include one or more magnetic disks such as one or more internal hard disks, one or more removable disks, one or more magneto-optical disks, one or more CD-ROM or DVD-ROM disks, etc., on which instructions and/or data may be stored to facilitate the operation of processor 602. Input device 610 may include a keyboard, a mouse, a voice-controlled input device, a touch sensitive input device (e.g., a touch screen), and/or the like for receiving user inputs to apparatus 600.

It should be noted that apparatus 600 may operate as a standalone device or may be connected (e.g., networked, or clustered) with other computation devices to perform the functions described herein. And even though only one instance of each component is shown in FIG. 6, a skilled person in the art will understand that apparatus 600 may include multiple instances of one or more of the components shown in the figure.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description.

What is claimed is:

1. An apparatus, comprising:
at least one processor configured to:
obtain, based on a first two-dimensional (2D) image depicting a first view of a person in a pose and a body shape, a first 2D feature representation;
obtain, based on a second 2D image depicting a second view of the person in the pose and the body shape, a second 2D feature representation; and
determine, based on a machine-learning (ML) model, a three-dimensional (3D) body model that represents the pose and the body shape of the person, wherein the ML model is trained to predict the 3D body model based at least on the first 2D feature representation and the second 2D feature representation, and wherein the ML model is trained using synthetically generated training data that includes at least a 3D training body model sampled from a human body model distribution, the synthetically generated training data further including respective 2D training feature representations associated with different camera views of the 3D training body model.

2. The apparatus of claim 1, wherein the first 2D feature representation includes a first feature map, a first mask, or a first heatmap associated with a plurality of joint locations of the person as depicted by the first 2D image, and wherein the second 2D feature representation includes a second feature map, a second mask, or a second heatmap associated with the plurality of joint locations of the person as depicted by the second 2D image.

3. The apparatus of claim 1, wherein the 3D body model that represents the pose and the body shape of the person includes a parametric mesh model or a non-parametric mesh model.

4. The apparatus of claim 1, wherein:
each of the different camera views of the 3D training body model is associated with a respective set of camera parameters sampled from a camera viewpoint distribution;
the respective 2D training feature representation associated with each of the different camera views is obtained based on features extracted from a 2D image that corresponds to a projection of the 3D training body model into a 2D image space; and
the projection of the 3D training body model into the 2D image space is based on the respective set of camera parameters associated with the each of the different camera views.

5. The apparatus of claim 1, wherein the ML model is used to inverse-project the first 2D feature representation and the second 2D feature representation into a 3D space to obtain a first set of 3D features and a second set of 3D features, respectively, the ML model further used to:
obtain a first 3D body model based on an intersection of the first set of 3D features and the second set of 3D features;
obtain a second 3D body model based on the first 3D body model and a union of the first set of 3D features and the second set of 3D features; and
determine the 3D body model that represents the pose and the body shape of the person based at least on the second 3D body model.

6. The apparatus of claim 5, wherein the 3D body model that represents the pose and the body shape of the person is determined further based on a weighted combination of the first set of 3D features and the second set of 3D features.

7. The apparatus of claim 6, wherein the first set of 3D features is weighed by a first consistency score in the weighted combination, and wherein the second set of 3D features is weighed by a second consistency score in the weighted combination.

8. The apparatus of claim 7, wherein the first consistency score is determined based on a difference between the first 2D feature representation obtained based on the first 2D image and a first projected 2D feature representation obtained by projecting the second 3D body model into a 2D image space, and wherein the second consistency score is determined based on a difference between the second 2D feature representation obtained based on the second 2D image and a second projected 2D feature representation obtained by projecting the second 3D body model into the 2D image space.

9. The apparatus of claim 1, wherein the ML model is implemented using an artificial neural network that comprises one or more convolutional layers.

10. The apparatus of claim 1, wherein the person is a patient and the at least one processor is further configured to position the person for a medical procedure based on the 3D body model that represents the pose and the body shape of the person.

11. A method for three-dimensional (3D) human body model recovery, the method comprising:
obtaining, based on a first two-dimensional (2D) image depicting a first view of a person in a pose and a body shape, a first 2D feature representation;
obtaining, based on a second 2D image depicting a second view of the person in the pose and the body shape, a second 2D feature representation; and
determining, based on a machine-learning (ML) model, a 3D body model that represents the pose and the body shape of the person, wherein the ML model is trained to predict the 3D body model based at least on the first 2D feature representation and the second 2D feature representation, and wherein the ML model is trained using synthetically generated training data that includes at least a 3D training body model sampled from a human body model distribution, the synthetically generated training data further including respective 2D training feature representations associated with different camera views of the 3D training body model.

12. The method of claim 11, wherein the first 2D feature representation includes a first feature map, a first mask, or a first heatmap associated with a plurality of joint locations of the person as depicted by the first 2D image, and wherein the second 2D feature representation includes a second feature map, a second mask, or a second heatmap associated with the plurality of joint locations of the person as depicted by the second 2D image.

13. The method of claim 11, wherein the 3D body model that represents the pose and the body shape of the person includes a parametric mesh model or a non-parametric mesh model.

14. The method of claim 11, wherein:
each of the different camera views of the 3D training body model is associated with a respective set of camera parameters sampled from a camera viewpoint distribution;
the respective 2D training feature representation associated with each of the different camera views is obtained based on features extracted from a 2D image that corresponds to a projection of the 3D training body model into a 2D image space; and
the projection of the 3D training body model into the 2D image space is based on the respective set of camera parameters associated with the each of the different camera views.

15. The method of claim 11, wherein the ML model is used to inverse-project the first 2D feature representation and the second 2D feature representation into a 3D space to obtain a first set of 3D features and a second set of 3D features, respectively, the ML model further used to:
obtain a first 3D body model based on an intersection of the first set of 3D features and the second set of 3D features;
obtain a second 3D body model based on the first 3D body model and a union of the first set of 3D features and the second set of 3D features; and
determine the 3D body model that represents the pose and the body shape of the person based at least on the second 3D body model.

16. The method of claim 15, wherein the 3D body model that represents the pose and the body shape of the person is determined further based on a weighted combination of the first set of 3D features and the second set of 3D features.

17. The method of claim 16, wherein the first set of 3D features is weighed by a first consistency score in the weighted combination, and wherein the second set of 3D features is weighed by a second consistency score in the weighted combination.

18. The method of claim 17, wherein the first consistency score is determined based on a difference between the first 2D feature representation obtained based on the first 2D image and a first projected feature representation obtained by projecting the second 3D body model into a 2D image space, and wherein the second consistency score is determined based on a difference between the second 2D feature representation obtained based on the second 2D image and a second projected feature representation obtained by projecting the second 3D body model into the 2D image space.

19. The method of claim 11, wherein the person is a patient and the method further comprises positioning the person for a medical procedure based on the 3D body model that represents the pose and the body shape of the person.

20. A non-transitory computer-readable medium comprising instructions that, when executed by a processor included in a computing device, cause the processor to implement the method of claim 11.
